(19) United States
(12) Patent Application Publication
(10) Pub. No.: US 2026/0204293 A1
(43) Pub. Date: Jul. 16, 2026

(54) INTERACTIVE VIDEO EDITING AND PLAYBACK WITH 3D OBJECT MANIPULATION

(71) Applicant: Microsoft Technology Licensing, LLC, Redmond, WA (US)

(72) Inventors: Brock Andrew KENZLER, Brisbane (AU); Soeren BALKO, Brookfield (AU)

(21) Appl. No.: 19/023,184

(22) Filed: Jan. 15, 2025

(51) Int. Cl. G11B 27/036; G06F 3/04845; G06F 3/04847; G11B 27/34

(52) U.S. Cl. CPC G11B 27/036; G06F 3/04845; G06F 3/04847; G11B 27/34

(57) ABSTRACT

Disclosed solutions provide for interactive video editing and playback with three dimensional (3D) object manipulation. Examples enable video players to display both an underlying static video along with a 3D object as dynamic content. The video editor presents a settings editor that enables the creator of the video to specify the ability of viewers to interact with the 3D object. The video viewer exposes settings for the dynamic content to enable users to reconfigure the display of the 3D dynamic content, making the video rendering an interactive experience. Use of references (e.g., URLs) within the dynamic content enables videos distributed in the new format updateable and correctable, such that information that is subject to change may be kept current, and informational errors introduced at the time of the video production may be corrected—without requiring creation and distribution of a substitute video file.

### BACKGROUND

Video is a domain that is currently strictly separated between editing and playback experiences, each of which cater to different audiences and use distinct software tools and capabilities. Common video editors, such as Clipchamp and others, enable users to assemble a timeline of media assets and effects, which they can subsequently export into a playable output video file (e.g., an MP4 file or another video file format). Common video players, such as Windows Media Player and others, are capable of playing video files in common video file formats, but with a constrained set of operations inspired by the physical buttons of VCRs, such as play, pause, seek, adjust playback speed, performing seek operations, and similar simple interactions. These operations do not allow for altering the content of the video being played.

Substantive changes to the video being displayed, and user interactions with individual objects displayed within the video (i.e., components less than the entire video frame) are not possible. In this sense, current conventional videos are static (i.e., their contents are fixed). Due to the limited available user operations, a viewer will typically merely start the video, possibly pausing, rewinding, fast forwarding, and/or changing playback speed, until the video playback completes or the viewer stops the playback.

Thus, video creators or editors must tailor the video content for viewing within the bounds of the traditional (tightly-limited) viewing operations. Further changes to the video, such as correcting errors in source material used (e.g., data displayed within the video), updating source material with newer information when it becomes available, or adjusting the viewing perspective of the source material is not possible after finalizing the video editing process, and saving and distributing the playable output video file. Updating a video with more current (or accurate) information, requires creation of a substitute video file and distributing the substitute with the hope that future viewers see the substitute video instead of the original video.

### SUMMARY

The disclosed examples are described in detail below with reference to the accompanying drawing figures listed below. The following summary is provided to illustrate some examples disclosed herein.

Solutions disclosed herein provide for interactive video editing and playback with three dimensional (3D) object manipulation. Examples generate a timeline in a video editor; generate a timeline synchronized to the static video data; receive, into the video editor, dynamic content comprising a 3D object; identify, within the timeline, a start time for presenting the dynamic content along with the static video data; present, in the video editor, a settings editor having settings for display of the 3D object, wherein the settings for display of the 3D object comprises at least one setting selected from the list consisting of: a zoom factor, a viewing parameter, and an interactive setting; and store, by the video editor, as an output video file, the static video data, metadata comprising the timeline, the dynamic content, and the settings for display of the 3D object.

Additional examples open, by a video player, a video file, the video file comprising static video data, dynamic content comprising a 3D object, metadata comprising a timeline, and settings for display of the 3D object, wherein the timeline comprises a start time for presenting the dynamic content along with the static video data; play the static video data; and based on at least the start time for presenting the dynamic content, display the 3D object along with the static video data according to the settings for display of the 3D object, wherein the settings for display of the 3D object comprises a zoom factor and/or a viewing parameter.

### BRIEF DESCRIPTION OF THE DRAWINGS

The disclosed examples are described in detail below with reference to the accompanying drawing figures listed below:

FIG. 1 illustrates an example architecture that advantageously provides for interactive video editing and playback with three dimensional (3D) object manipulation;

FIG. 2 illustrates exemplary dynamic content, as may be used in examples of the architecture of FIG. 1;

FIG. 3 illustrates exemplary metadata, as may be used in examples of the architecture of FIG. 1;

FIG. 4 illustrates an exemplary output video file, as may be generated in examples of the architecture of FIG. 1;

FIG. 5A illustrates an exemplary scenario of creating a video project using the video editor of FIG. 1;

FIG. 5B illustrates an exemplary alternative scenario for a timeline of a video project created using the video editor of FIG. 1;

FIG. 6A illustrates an exemplary scenario of viewing the dynamic content of FIG. 2 using the new video player of FIG. 1;

FIG. 6B illustrates the exemplary scenario of FIG. 6A after receiving user adjustment input;

FIGS. 7, 8A, and 8B show flowcharts illustrating exemplary operations that may be performed when using example architectures, such as the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

Disclosed solutions provide for interactive video editing and playback with three dimensional (3D) object manipulation. Examples enable video players to display both an underlying static video along with a 3D object as dynamic content. The video editor presents a settings editor that enables the creator of the video to specify the ability of viewers to interact with the 3D object. The video viewer exposes settings for the dynamic content to enable users to reconfigure the display of the 3D dynamic content, making the video rendering an interactive experience. Use of references (e.g., URLs) within the dynamic content enables videos distributed in the new format to be updateable and correctable, such that information that is subject to change may be kept current, and informational errors introduced at the time of the video production may be corrected—without requiring creation and distribution of a substitute video file. For example, references may be used to replace dynamic content (e.g., the 3D object at a URL may be swapped for another, while the URL in the distributed video project file remains the same). This differs from manipulating a 3D object, such as adjusting viewing (camera) camera position and orientation, or altering properties of the 3D object during playback time.

Aspects of the disclosure solve multiple problems that are necessarily rooted in computer technology, and render use of computing platforms more efficient in highly common use cases, by providing the practical result of enabling already-distributed video files to be updated and/or corrected without requiring expensive creation and distribution of substitute video files. Additionally, examples convert video files, which have been static since their inception, into interactive experiences in which viewers are able to tailor and customize the presentation of individual objects within the video project. This significantly improves the ubiquitous use of computers for viewing video files distributed to large numbers of users over the internet, such as by emailing, posting on websites for download or online viewing, and shared over social media.

These advantageous results are accomplished, at least in part, by presenting a settings editor having settings for display of the 3D object, wherein the settings for display of the 3D object comprises at least one setting selected from the list consisting of: a zoom factor (scaling factor), a viewing parameter, and an interactive setting. Further, while displaying the 3D object, based on at least the interactive setting permitting user adjustment, and further based on at least receiving the user adjustment input, users may adjust the zoom factor and/or a viewing parameter of the 3D object. It is common to represent 3D objects as scene graphs in 3D space. Interactions with the 3D object that adjust a viewing parameter may include moving the camera around in 3D space (i.e., moving the position of the viewing point), and changing the viewing angle (azimuth and/or elevation where the viewing angle is pointing). Other viewing parameter adjustments may include adding light sources, and adding or removing other objects within the scene graph, or changing position and orientation (i.e., applying affine transformations).

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

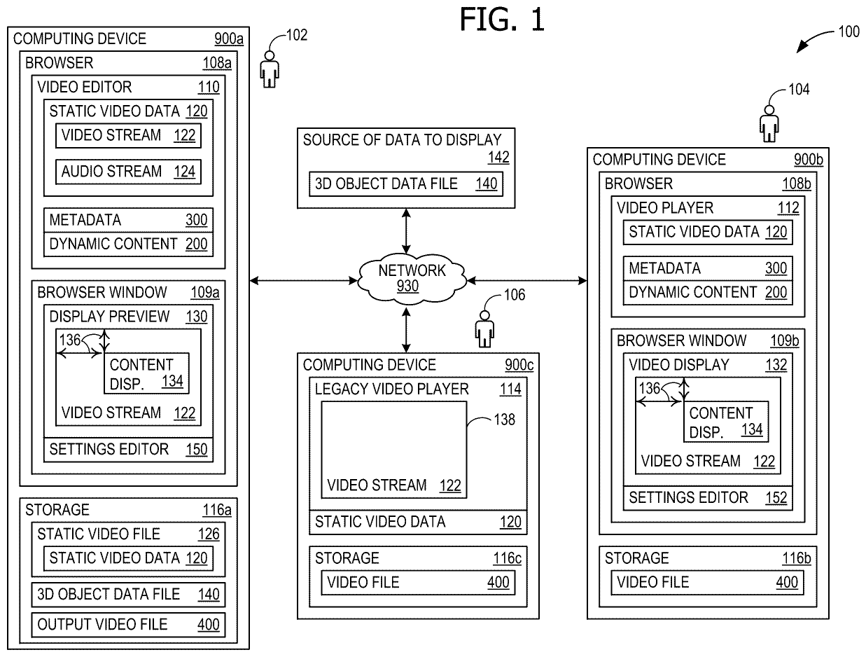

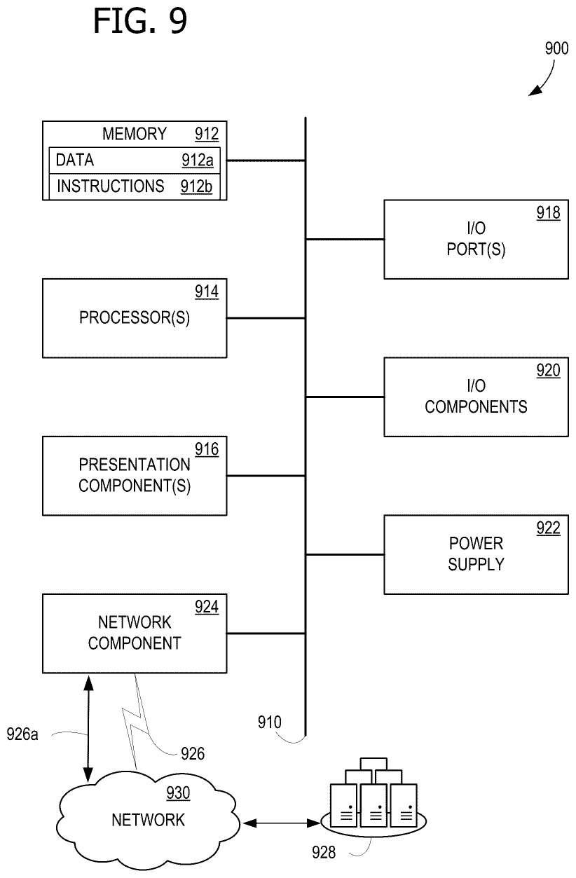

FIG. 1 illustrates an example architecture 100 that advantageously provides for interactive video editing and playback with 3D object manipulation. A user 102 (a video creator) wishes to create a new video project combining both static video and a 3D object as dynamic content with which a viewer (e.g., user 104) may interact. User 102 is using a computing device 900a, which may be an example of computing device 900 of FIG. 9. Computing device 900a has an internet browser 108a, which displays an internet browser window 109a, and a storage 116a. Storage 116a holds static video data 120 in a static video file 126. Static video data 120 forms the underlying basis for the new video project, to which user 102 will add dynamic content 200.

Static video data 120 has a static video stream 122, and a static audio stream 124, which is synchronized to provide a sound track to static video stream 122. Static video data 120 (including static video stream 122 and static audio stream 124) are identified as static, because after finalization and distribution, the video and audio streams are not changeable. That is, the content is immutable by standard video players (such as a legacy video player 114, described below). In some examples, static video file 126 uses a legacy video file format, such as MP4, MOV, AVI, WMV, MKV, WebM, OGV, or QuickTime file format (QTFF). Some common media formats (e.g., MP4 containers) allow for multiple video streams, which may be used for different viewing perspectives (e.g., in sports broadcasts), and multiple audio streams (e.g., different languages). Some media players allow for switching between these static audio or video streams. Adjustment of volume, and switching among different static audio streams and/or static video streams does not render the content dynamic, as the term is used herein.

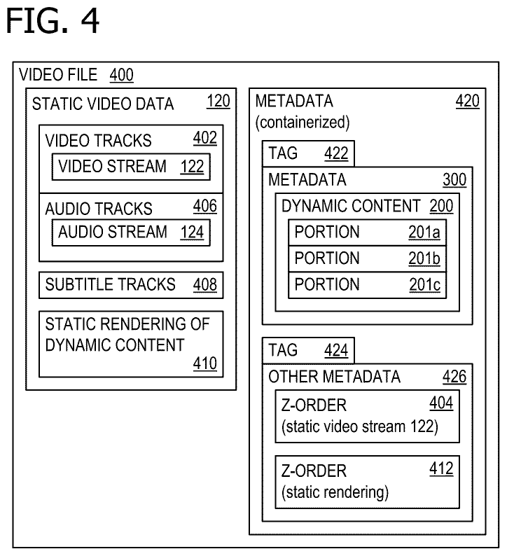

User 102 uses a video editor 110 to create the project and export (store) it as an output video file 400, such as in storage 116a. User 102 then distributes (output) video file 400 to other users (viewers), such as a user 104 and a user 106, such as by emailing, posting on a website, or sharing on social media. Video file 400 is shown in further detail in FIG. 4. Video editor 110 loads static video file 126 to start the project. In some examples, video editor 110 comprises a plug-in to internet browser 108a, whereas in some other examples, video editor 110 executes remotely from internet browser 108a, but is shown within internet browser window 109a (i.e., the user interface of video editor 110 is displayed in internet browser window 109a). In some examples, video editor 110 executes as a stand-alone application on computing device 900a.

Using video editor 110, user 102 adds dynamic content 200 to the video project by loading a 3D object 202a, held in an object data file 140. Dynamic content 200 is the additional data to display along with static video data 120, when dynamic content 200 is a visual element, although dynamic content 200 may also include audio elements that are played (in addition to static audio stream 124). FIG. 1 shows two options for sourcing 3D object 202a, either loading object data file 140 (holding 3D object 202a) directly from storage 116a, or from a source 142 across a computer network 930. In some examples, 3D object 202a is a vector object, and may be rendered as a scene graph using 3D vector-based graphics. Raster data may also be used for 3D objects.

Adding 3D object 202a may be accomplished by either including a reference (e.g., a URL) to object data file 140, located on source 142, or by including 3D object 202a as inline content (i.e., 3D object 202a will be fully contained within video file 400). When adding video file 400 via reference, video file 400 is smaller and display of 3D object 202a is kept up-to-date as it is updated on source 142—even years after the finalization and distribution of video file 400. Source 142 may be a server (such as another example of computing device 900), and computer network 930 may include the internet, as described below in relation to FIG. 9. When adding 3D object 202a as inline data, video file 400 is larger but availability of source 142 is not a potentially restraining issue.

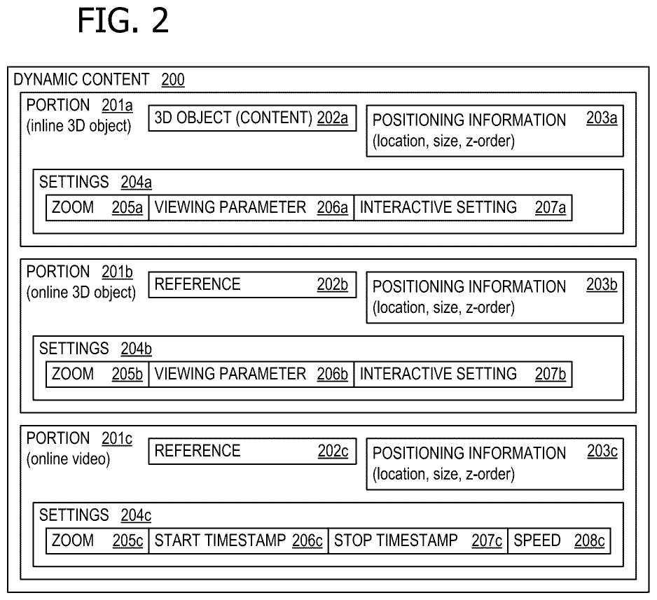

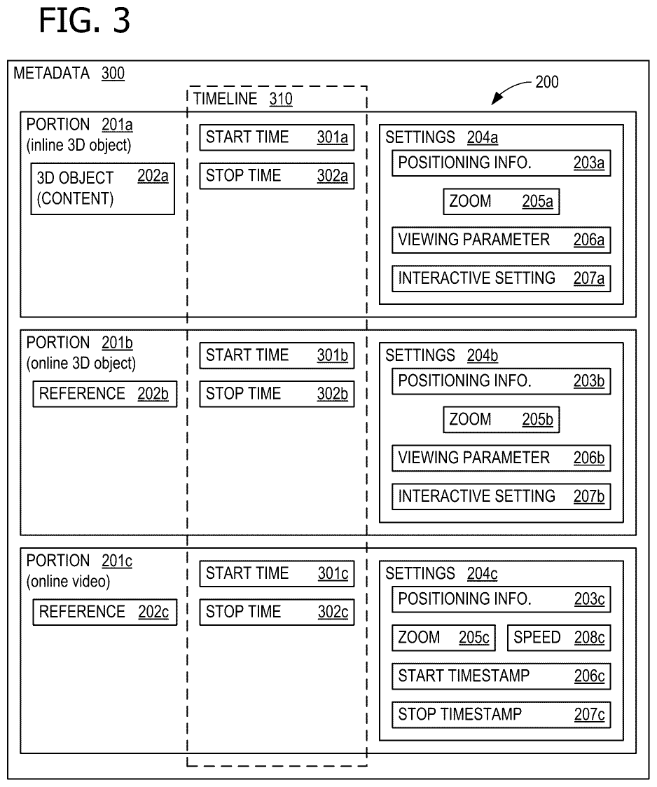

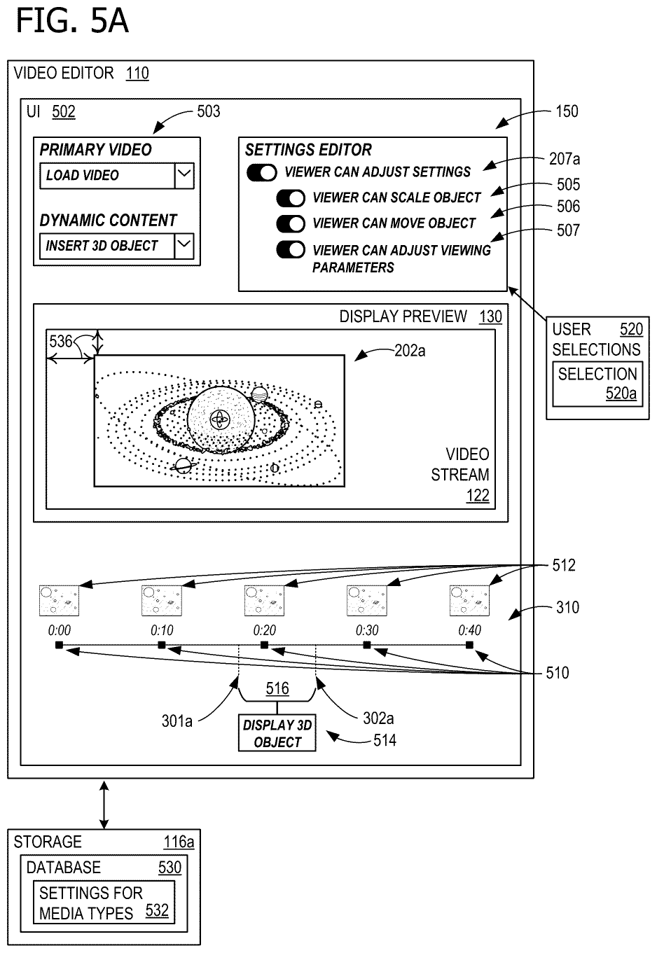

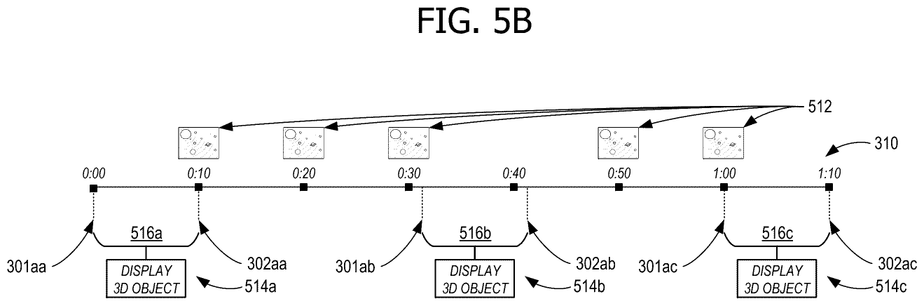

As user 102 edits the video project, a display preview 130 of video editor 110 shows a display 134 of dynamic content 200 (or at least a portion of dynamic content 200—see FIGS. 2 and 5) along with static video data 120. Using a settings editor 150 of video editor 110, user 102 is able to set several parameters for the presentation of dynamic content 200, such as when during the playing of static video data 120 dynamic content 200 (or portions thereof) appear (i.e., a start time) and are removed (i.e., a stop time). Additionally, the presentation size of dynamic content 200, and its positioning and z-order in relation to other content on the timeline. Some examples use z-ordering to layer the displayed content. A z-order is an ordering of overlapping objects, that identifies which object is on top and which is beneath (and thus may be obscured). This is described in further detail in reference to FIG. 5A. The start and stop times may be specified within a timeline 310 of metadata 300, which is shown in further detail in FIG. 3.

Other parameters for the presentation of dynamic content 200, which may be set by user 102 include a relative positioning 136 of display 134 of dynamic content 200 relative to the display of static video data 120 (i.e., display of static video stream 122, since static audio stream 124 is played as audio). Relative positioning 136 is illustrated as horizontal and vertical offsets from the top left corner of static video stream 122, although other ways to specify positioning may be used. Further example parameters for presentation of dynamic content 200 are shown in FIG. 2. When user 102 is satisfied with the video project, it is saved to storage 116a as output video file 400 and distributed.

User 104 is one of the viewers, and receives video file 400 into a storage 116b of a computing device 900b, which may be another example of computing device 900 of FIG. 9. User 104 uses a video player 112 that is able to display (present) dynamic content 200 along with static video data 120. In some examples, video player 112 comprises a plug-in to internet browser 108b on computing device 900b, whereas in some other examples, video player 112 executes remotely from internet browser 108b, but is shown within an internet browser window 109b of internet browser 108b (i.e., the user interface of video player 112 is displayed in internet browser window 109b). In some examples, video player 112 executes as a stand-alone application on computing device 900b.

Video player 112 loads video file 400 and extracts static video data 120, metadata 300, and dynamic content 200. Video player 112 plays static video data 120 within a video display 132 of video player 112. At the times specified by timeline 310 of metadata 300, the various portions of dynamic content 200 are displayed along with static video data 120 (i.e., static video stream 122). Some examples of video player 112 may leverage online 3D object rendering and display engines, such as Babylon.js, or a full gaming engine. Babylon.js is a JavaScript library and 3D engine for displaying real time 3D graphics in a web browser via HTML5.

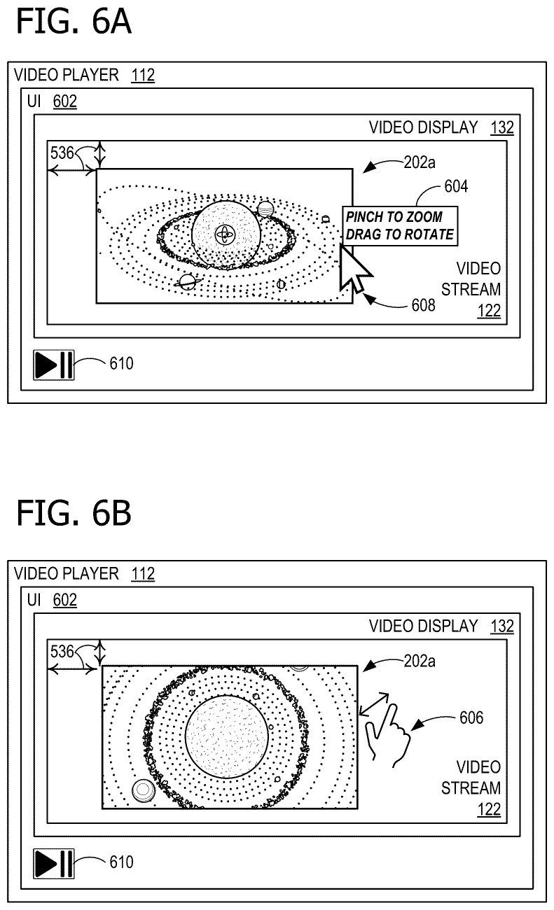

Dynamic content 200 is positioned according to relative positioning 136 of display 134 of dynamic content 200 relative to the display of static video data 120. In some examples, user 104 is able to use a settings editor 152 of video player 112 adjust at least some parameters for the presentation of dynamic content 200. The ability of user 104 to adjust parameters of the presentation of dynamic content 200 may have been specified by user 102 and the limits/permissions stored within metadata 300 or dynamic content 200 itself. In some examples, settings of the parameters of the presentation of dynamic content 200 are exposed via an API accessed by video player 112. This is shown in further detail in relation to FIG. 6.

In some scenarios, another user 106 also receives video file 400. User 106 uses a computing device 900c (e.g., another example of computing device 900 of FIG. 9). Computing device 900c has a storage 116c and a legacy video player 114. Video player 114 may run as a standalone application on computing device 900c or within an internet browser. Video player 114 loads video file 400 from storage 116c, but lacks the functionality to display dynamic content 200 along with static video data 120.

Generally, video players ignore video file content that is tagged with a tag that the video player does not recognize. As is described below, dynamic content 200 is containerized and tagged, so that it is recognized, by video player 112, as holding dynamic content 200. However, legacy video players, such as video player 114, ignore dynamic content 200 and do not display it. This feature of legacy video players renders the disclosure herein backwards-compatible, such that static video is shown by legacy video players, while newer video players, that are compatible with the disclosure herein, do display dynamic content 200.

Video player 114 ignores containerized metadata having tags that legacy video player 114 is not programmed to recognize, but plays static video data 120 (static video stream 122 and static audio stream 124), showing a display 138 of static video stream 122. This backwards compatibility thus introduces a compromise: static video data 120 is viewable by user 106, but without dynamic content 200 as dynamic objects. In some examples, dynamic content 200 may be represented by static placeholder content instead, such as a rendering of a 3D object which may be animated (i.e., a camera may “fly” through a rendered 3D scene, or a 3D object rotates).

FIG. 2 illustrates further detail for dynamic content 200, with seven separate portions shown. Some examples may have a different count of dynamic content portions, each of which may be displayed separately, in different positions, and/or with different start and stop times. Portion 201a of dynamic content 200 is an inline 3D object, specifically 3D object 202a, in which the content to display is contained within dynamic content 200, possibly encapsulated in a common data file format, and stored within video file 400. Positioning information 203a specifies relative positioning 136 (location within the available display area) for display 134 of portion 201a, as well as sizing (i.e., maximum dimensions of what is displayed as dynamic content 200 within the available display area), and the z-order for 3D object 202a. Settings 204a specify parameters for the presentation (e.g., display) of portion 201a of dynamic content 200, as set by user 102 using settings editor 150 of video editor 110. For example, for 3D object 202a of portion 201a, settings 204a has a zoom factor 205a, a viewing parameter 206a, and an interactive setting 207a that specifies whether a viewer (e.g., user 104) is able to adjust zoom factor 205a and/or viewing parameter 206a. Viewing parameter 206a may include any of the viewing angle (azimuth and elevation), the position of the viewing point (i.e., camera position in 3D space), the field of view, and lighting and shading effects. If 3D object 202a is an encapsulated data file, it may be in a common a 3D object file format.

Portion 201b of dynamic content 200 is an online sourced 3D object, included within dynamic content 200 by a reference 202b, such as a URL or hyperlink, (as opposed to being included as data that is encapsulated within video file 400). For example, online sourced video may be retrieved from object data file 140, which is sourced from source 142. In such a scenario, reference 202b points to (references) source 142, and 3D object 202a is brought into the video project by reference, rather than being included as inline data. This alternative to providing 3D object 202a as inline data permits display of 3D object 202a to be kept up-to-date as it is updated on source 142.

Positioning information 203b specifies relative positioning 136 for display 134 of portion 201b. Settings 204b specify parameters for the presentation of portion 201b of dynamic content 200, as set by user 102 using settings editor 150 of video editor 110. For example, for portion 201b, settings 204b has a zoom factor 205b, a viewing parameter 206b (azimuth and elevation), and an interactive setting 207b that specifies whether a viewer (e.g., user 104) is able to adjust zoom factor 205b and/or viewing parameter 206b.

Portion 201c of dynamic content 200 is an online sourced video, included within dynamic content 200 by a reference 202c, such as a URL or hyperlink. In this example, the video is only two dimensional (2D) video data, so an interactive setting is not required. An online sourced video may be a data file sourced from source 142. In such a scenario, reference 202c points to source 142. This permits display of the online sourced video to be kept up-to-date as it is updated on source 142. Positioning information 203c specifies relative positioning 136 for display 134 of portion 201c of dynamic content 200. Settings 204c specify parameters for the presentation of dynamic content 200, as set by user 102 using settings editor 150 of video editor 110. The settings for a portion of dynamic content 200 may be specific to the type of content. For example, for the online sourced video of portion 201c, settings 204c has a zoom factor 205c, a start timestamp 206c, a stop timestamp 207c, and a speed indication 208c (a playback speed, for data that plays automatically, such as a video or an animated object). Note that start timestamp 206c and stop timestamp 207c are time indices within the online video of starting and stopping play, in the event that the entirety of the online sourced video is not played (i.e., only an excerpt of the online sourced video is played as dynamic content 200). Speed indication 208c enables playing the online sourced video at a different speed relative to static video data 120.

FIG. 3 illustrates further detail for metadata 300. Metadata 300 includes dynamic content 200, and also includes timeline 310 that spans the portions of dynamic content 200, and which has a start time and/or a stop time for various ones of the portions. The start times and stop times for the different portions may all be independent (and thus different), with the limitation that any portions of dynamic content that start at the very beginning of playing the resulting video will have the same start times, as well as any portions of dynamic content that do not stop until the very end of playing the resulting video will similarly have the same stop times.

As illustrated, portion 201a (inline 3D object) has a start time 301a and a stop time 302a, indicating when during the playback of static video data 120, 3D object 202a is to be displayed. Also as illustrated, portion 201b (online sourced 3D object) has a start time 301b and a stop time 302b, indicating when during the playback of static video data 120, 3D object 202a is to be displayed. Portion 201c (online sourced video) has a start time 301c and a stop time 302b. These are distinguishable from start timestamp 206c and stop timestamp 207c in that start time 301c refers to the timing of playing static video data 120, whereas start timestamp 206c is a time index within the source video that is played as dynamic content, and stop time 302c refers to the timing of playing static video data 120, whereas stop timestamp 207c is another time index of the source video.

FIG. 4 illustrates further detail for video file 400. Video file 400 contains static video data 120 and containerized metadata 420. Static video data 120 contains a video tracks data field 402 that holds static video stream 122, and which is given a z-order 404, that is held in other metadata 426 within containerized metadata 420. Other metadata 426 is tagged with a tag 424 that is recognized by both video player 112 and (legacy) video player 114. Thus, both video player 112 and video player 114 will display static video stream 122 according to z-order 404. Static video data 120 also contains an audio tracks data field 406 that holds static audio stream 124, and a static rendering 410 of dynamic content 200. A z-order 412 for static rendering 410 is within other metadata 426. Static video data 120 may further contain a subtitle tracks data field 408.

Because video player 114 recognizes tag 424, video player 114 will display static rendering 410 of dynamic content 200 according to z-order 412 (e.g., possibly obscuring all or a portion of static video stream 122). Video player 112 also recognizes tag 424, but video player 112 will obscure static rendering 410 with dynamic content 200 itself.

Containerized metadata 420 also holds metadata 300, which is tagged with a tag 422 that is recognized by video player 112, but not legacy video players, such as video player 114. Thus, video player 114 will ignore metadata 300 and dynamic content 200. The z-order for each of the portions of dynamic content 200, including 3D object 202a, is within the positioning data (see FIG. 2), and will result in video player 112 placing dynamic content 200 over top of static rendering 410 of dynamic content 200.

FIG. 5A illustrates an exemplary scenario of creating a video project using video editor 110. Video editor 110 has a user interface 502 that enables loading static video data 120 and dynamic content, such as 3D object 202a with a menu-driven load window 503. Other ways of loading static video data 120 and 3D object 202a are also feasible. To start the video project, user 102 creates timeline 310 as a data object, which initially may be empty. In this described example, user 102 loads static video data 120 first, prior to loading 3D object 202a, although the order may be reversed, if convenient. The location of static video data 120 is specified within timeline 310.

A set of time points 510 is illustrated at every 10 seconds, each showing a still frame, such that images (display images 512) from static video data 120 are displayed at time points 510 in timeline 310. In this illustrated scenario, timeline 310 is 40 seconds long, dictated by the length of static video data 120. User 102 loads 3D object 202a next, although in some examples, the order of loading objects may differ. Video editor 110 identifies the type of dynamic content and pulls settings for media types 532 from a database 530, which may be local in storage 116a or online. User 102 may specify the z-order may be specified, in order to place dynamic content 200 on top of (thus obscuring) all or a portion of static video data 120 that would otherwise be displayed.

In some examples, a static rendering of dynamic content 200 that would be visible in legacy video players, is placed atop a portion of static video data 120 in the z-order, and then dynamic content 200 is placed atop static rendering of dynamic content 200. That is, in the z-order, static video data 120 is on the bottom, dynamic content 200 is on the top layer, and a static rendering of dynamic content 200 is in the middle. With this scheme, legacy video players are not entirely deprived of the addition of dynamic content 200, only just the ability to interact with it.

Settings for media types 532 is used to populate settings editor 150 for settings that are relevant to the type of dynamic content loaded (e.g., settings 204a for 3D object 202a). Settings 204a includes interactive setting 207a that either permits or prohibits user adjustment (i.e., viewer adjustment) of zoom factor 205a and/or viewing parameter 206a, among possibly a larger set of settings. In some examples, interactive setting 207a is not merely binary, but has further-refined settings identifying whether the viewer (i.e., user 104) is able to adjust specific ones of settings 204a.

A control 505 constrains whether the viewer is able to change the viewing properties of 3D object 202a. For example, control 505 specifies whether user adjustment of zoom factor 205a is permitted; a control 506 specifies whether user adjustment of display position 536 of 3D object 202a is permitted; and a control 507 specifies whether user adjustment of a viewing parameter 206a is permitted (i.e., any of viewing angle, the position of the viewing point, the field of view, and lighting). Other controls may be provided in some examples. Similarly to relative positioning 136 of display 134 of dynamic content 200 in FIG. 1, display position 536 of 3D object 202a is illustrated as horizontal and vertical offsets from the top left corner of static video stream 122, although other ways to specify positioning may be used.

The controls of settings editor 150 are adjusted by user selections 520, which includes a user selection 520a as an individual input for one of the controls. In some examples, settings 204a and the controls of settings editor 150 may be viewed as dynamic variables.

Display preview 130 shows static video stream 122, as user 102 scrolls along timeline 310. User 102 is able to specify start time 301a for the start of displaying 3D object 202a, and also stop time 302a. This may be accomplished by a user interaction, of which an ever-increasing number of control-type user interactions are available. Examples include clicking a mouse button while a pointer control (see FIG. 6) is over the desired time of timeline 310, a touch on a touchscreen of computing device 900a, voice control, and others. The list of available user interactions, that may be used for control is growing, and future supported user interactions may also be used.

As illustrated, a dynamic section indicator 514 indicates dynamic section 516 of timeline 310 when 3D object 202a is to be displayed for a viewer. The specification of start time 301a and stop time 302a may also be considered user selections 520. As other user selections 520 (provided by any supported user interactions), user 102 is able to drag 3D object 202a to the desired display position 536 within display preview 130, as well as size it, scale it, and control viewing parameter 206a for the default view that is to be seen by viewers, such as user 104 (if the viewer does not interact with 3D object 202a to change any of settings 204a). FIG. 5B illustrates an exemplary alternative scenario of displaying 3D object 202a in parallel with playing static video data 120. In the scenario described above, for FIG. 5A, the display of 3D object 202a is concurrent with static video data 120—at the same time as static video data 120 is playing. Timeline 310 is not extended, but is the same length as static video data 120. However, other scenarios are possible, and which also may be described as being in parallel with the playing of static video data 120 because they are contemporaneous with the playing of static video data 120 and are within the same video project.

For example in FIG. 5B, a dynamic section indicator 514a indicates a dynamic section 516a that begins and ends prior to the start of playing static video data 120. This is essentially a preview for static video data 120 and extends the playing time of the video project to be longer than static video data 120. That is, timeline 310 is extended beyond the length of static video data 120 by at least the length of dynamic section 516a. The video project begins playing at start time 301aa, which in this case is 0:00 (the very beginning), with the display of 3D object 202a until stop time 302aa. At stop time 302aa (illustrated as 0:10, 10 seconds), video player 112 ceases displaying 3D object 202a, and then starts playing static video data 120.

Similarly, a dynamic section indicator 514c indicates a dynamic section 516c that begins and ends after the completion of playing static video data 120. This is essentially an epilog for static video data 120 and also further extends the playing time of the video project. That is, timeline 310 is again extended beyond the length of static video data 120 by at least the length of dynamic section 516c. The video project finishes playing static video data 120 and then starts displaying 3D object 202a at start time 301ac, which in this case is 1:00 (one minute). At stop time 302ac (illustrated as 1:10, 10 seconds), video player 112 ceases displaying 3D object 202a, and the video project completes.

In yet a further extension of time, a dynamic section indicator 514b indicates a dynamic section 516b that begins and ends as an interruption to the playing static video data 120. That is, static video data 120 is paused (possibly removed from view), and 3D object 202a is displayed from start time 301ab until stop time 302ab. At stop time 302ab, static video data 120 resumes playing. That is, timeline 310 is again extended beyond the length of static video data 120 by at least the length of dynamic section 516b. Timeline is now 1:10 long, which is the 40 seconds of static video data, plus the lengths of dynamic section 516a, dynamic section 516b, and dynamic section 516c (10 seconds each), for a total of 70 seconds (1 minute, 10 seconds).

FIG. 6A illustrates an exemplary scenario of viewing 3D object 202a in parallel with static video data 120, using video player 112. Video player 112 has a UI 602 that includes a video display 132 and playing controls 610, shown as a play/pause button. Other playing controls may also be provided in some examples, such as fast forward, rewind, and a play timeline in which the current video frame may be selected by dragging an indicator along the play timeline. 3D object 202a is displayed at display position 536, as specified by positioning information 203a.

When user 104 employs some user interactions centered on 3D object 202a, an indication 604 that a user adjustment is available is displayed to user 104. This may take the form of user 104 positioning (and hovering) a pointer control 608, such as a mouse cursor, over 3D object 202a (which is at display position 536). If computing device 900b has a touchscreen, rather than pointer control 608 hovering over display position 536 of 3D object 202a, a touch on the touchscreen may also trigger the display of indication 604. As illustrated, indication 604 instructs user 104 how to change the scaling of 3D object 202a (i.e., change zoom factor 205a), as well as change viewing parameter 206a. Informing user 104 how to accomplish these tasks also informs user that these user adjustments are available. In some examples, indication 604 comprises a tooltip. Other user adjustments, if available, such as positioning and toggling the display, may also be included in the instructions of indication 604.

FIG. 6B illustrates the display of exemplary scenario of 3D object 202a after receiving user adjustment input to change (adjust) viewing parameter 206a. Viewing parameter 206a may include any of the viewing angle (azimuth and elevation), the position of the viewing point (i.e., camera position in 3D space), the field of view, and lighting and shading effects. A user adjustment input 606 is shown as a pinching action to change zoom factor 205a, such as to zoom out (pinching inwards) or zoom in (spreading fingers).

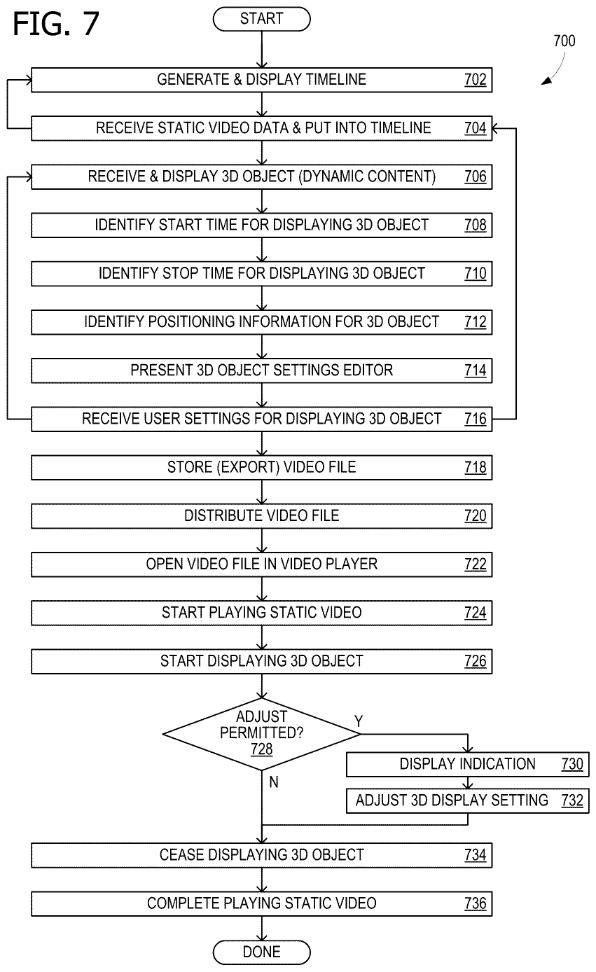

FIG. 7 shows a flowchart 700 illustrating exemplary operations that may be performed by architecture 100. In some examples, operations described for flowchart 700 are performed by computing device 900 of FIG. 9. Flowchart 700 commences with video editor 110 generating timeline 310 in operation 702. In some examples, video editor 110 comprises a plug-in to internet browser 108a on computing device 900a, whereas in some other examples, video editor 110 executes remotely from internet browser 108b, but is shown within an internet browser window 109a of internet browser 108a (i.e., the user interface of video editor 110 is displayed in internet browser window 109a). In some examples, video editor 110 executes as a stand-alone application on computing device 900a.

Static video data 120 is loaded into video editor 110 in operation 704, and placed as an object (item) in timeline 310 (e.g., with its own start time and stop time). In some examples, static video data 120 may be loaded from a file and cropped in both time (i.e., selecting just a portion in time of the entire length) and frame content (i.e., cutting off portions of the viewable audio frames). Other changes may also be made, such as speeding up the playback time and adjusting audio volume and equalization.

Static video data 120 comprises both static video stream 122 and static audio stream 124 synchronized with static video stream 122. In some examples, receiving static video data 120 comprises, opening, by video editor 110, static video file 126 in a common video file format, wherein the common video file format may be a common video format, such as MP4, MOV, AVI, WMV, MKV, WebM, OGV, QTFF, and others.

Operations 704 and 702 iterate for as many static video clips are being used. Timeline 310 is displayed in video editor 110, and updated as each new item is added. Some examples also display images 512 from static video data 120 at time points 510 in timeline 310. Video editor 110 receives dynamic content 200 comprising 3D object 202a, and displays 3D object 202a in operation 706. In some examples, receiving 3D object 202a comprises, opening, by video editor 110, object data file 140 comprising a 3D object file format. In some examples, receiving 3D object 202a comprises receiving reference 202b (e.g., a URL or a hyperlink) to object data file 140 comprising a 3D object file format.

Further descriptions of FIG. 7 are for loading 3D object 202a as inline data, using start time 301a, stop time 302a, positioning information 203a, settings 204a, zoom factor 205a, viewing parameter 206a, and interactive setting 207a. However is should be understood that (except as specifically noted below), the description of FIG. 7 is also valid for referencing 3D object 202a as an online sourced data, with start time 301b, stop time 302b, positioning information 203b, settings 204b, zoom factor 205b, viewing parameter 20b, and interactive setting 207b.

Start time 301a, within timeline 310, is identified for displaying 3D object 202a along with static video data 120, such as by receiving user selection 520a, in operation 708, and stop time 302a, within timeline 310, is identified for ceasing display of 3D object 202a, such as by receiving user selection 520a, in operation 710. Positioning information 203a for positioning display 134 of 3D object 202a (a portion of dynamic content 200) relative to the display of static video data 120 is identified, such as by receiving user selection 520a, in operation 712.

Settings editor 150 is presented in video editor 110 in operation 714, although in some examples, operation 714 occurs prior to operation 708, because one or more of start time 301a, stop time 302a, and positioning information 203a is part of settings (204a. Settings editor 150 includes settings 204a for controlling display of 3D object 202a, such as zoom factor 205a, viewing parameter 206a, and interactive setting 207a. Interactive setting 207a either permits or prohibits user adjustment of zoom factor 205a and/or viewing parameter 206a of 3D object 202a. In some examples, interactive setting 207a further either permits or prohibits user adjustment of positioning display 134 of dynamic content 200. User selections 520 for settings 204a of settings editor 150 are received by video editor 110 in operation 716.

Operations 706-716 iterate for as many dynamic objects are being used. Also, multiple static and dynamic objects may be added to the video project, in any order. That is, flowchart 700 may go from operation 702 to 706 (skipping operation 704), and then later, move to operation 704 for any static video stream that is to be added to the video project.

Video editor 110 stores static video data 120, metadata 300 comprising timeline 310, dynamic content 200, and settings 204a for display of 3D object 202a as output video file 400 in operation 718. Operation 718 is commonly described as “exporting” a video project, which involves compositing and encoding static video and audio data into a video and audio stream using codecs such as H.264/AVC and AAC. Additionally, exporting a video project, with the novel capabilities described herein, further includes storing the dynamic content (e.g., 3D objects/scene graphs) using provisions of the media format (e.g., MP4). This incorporates the metadata and properties of the dynamic content, and/or a reference (e.g., a URL to a 3D scene graph stored at an external location) or embedded inline content.

Video file 400 is distributed, in operation 720, to other users (viewers), such as a user 104 and a user 106. This may be accomplished by emailing, posting on a website, or sharing on social media.

Video player 112 opens video file 400 in operation 722. In some examples, video player 112 comprises a plug-in to internet browser 108b on computing device 900b, whereas in some other examples, video player 112 executes remotely from internet browser 108b, but is shown within an internet browser window 109b of internet browser 108b (i.e., the user interface of video player 112 is displayed in internet browser window 109b). In some examples, video player 112 executes as a stand-alone application on computing device 900b.

Static video data 120 starts playing in operation 724. In operation 726, based on at least start time 301a, 3D object 202a is displayed along with static video data 120 according to settings 204a. Decision operation 728 determines whether interactive setting 207a permits user adjustment to settings 204a. If so, then while displaying 3D object 202a, indication 604 that a user adjustment is available is displayed in operation 730. In some examples, this display of indication 604 is based on at least pointer control 608 hovering over display position 536 of 3D object 202a. In some examples, pointer control 608 comprises a cursor or a touch on a touchscreen, and in some examples, indication 604 that a user adjustment is available comprises a tooltip. In operation 732, also while displaying 3D object 202a, based on at least receiving user adjustment input 606, adjusting the zoom factor 205a, viewing parameter 206a, and/or display position 536 of 3D object 202a. Some examples further permit toggling display of 3D object 202a off.

In operation 734, upon reaching stop time 302a for presenting dynamic content 200, video player 112 ceases display of 3D object 202a. Video player 112 completes playing static video data 120 in operation 736.

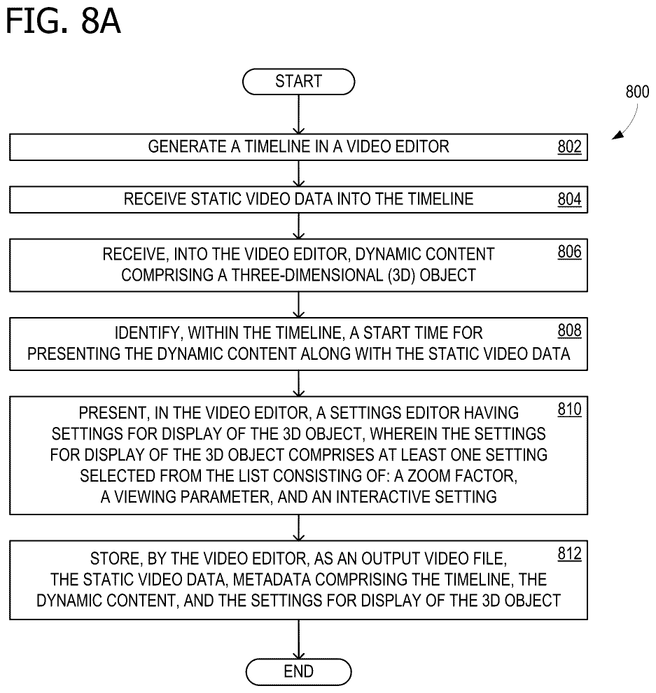

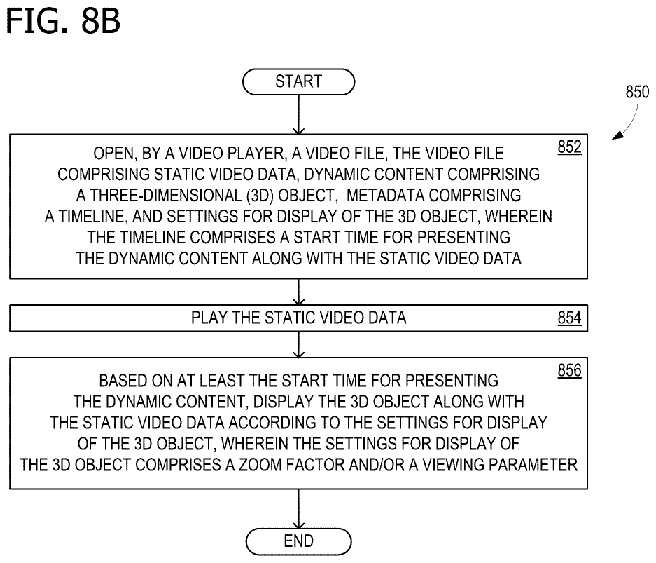

FIG. 8A shows a flowchart 800 illustrating exemplary operations that may be performed by architecture 100. In some examples, operations described for flowchart 800 are performed by computing device 900 of FIG. 9. Flowchart 800 commences with operation 802, which includes receiving static video data into a video editor. Operation 804 includes generating a timeline synchronized to the static video data. Operation 806 includes receiving, into the video editor, dynamic content comprising a 3D object.

Operation 808 includes identifying, within the timeline, a start time for presenting the dynamic content along with the static video data. Operation 810 includes presenting, in the video editor, a settings editor having settings for display of the 3D object, wherein the settings for display of the 3D object comprises at least one setting selected from the list consisting of: a zoom factor, a viewing parameter, and an interactive setting. Operation 812 includes storing, by the video editor, as an output video file, the static video data, metadata comprising the timeline, the dynamic content, and the settings for display of the 3D object.

FIG. 8B shows a flowchart 850 illustrating exemplary operations that may be performed by architecture 100. In some examples, operations described for flowchart 850 are performed by computing device 900 of FIG. 9. Flowchart 850 commences with operation 852, which includes opening, by a video player, a video file, the video file comprising static video data, dynamic content comprising a 3D object, metadata comprising a timeline, and settings for display of the 3D object, wherein the timeline comprises a start time for presenting the dynamic content along with the static video data.

Operation 854 includes playing the static video data. Operation 856 includes, based on at least the start time for presenting the dynamic content, displaying the 3D object along with the static video data according to the settings for display of the 3D object, wherein the settings for display of the 3D object comprises a zoom factor and/or a viewing parameter.

### Additional Examples

An example system comprises: a processor; and a computer-readable medium storing instructions that are operative upon execution by the processor to: generate a timeline in a video editor; receive static video data into the timeline; receive, into the video editor, dynamic content comprising a three-dimensional (3D) object; identify, within the timeline, a start time for presenting the dynamic content along with the static video data; present, in the video editor, a settings editor having settings for display of the 3D object, wherein the settings for display of the 3D object comprises at least one setting selected from the list consisting of:
a zoom factor, a viewing parameter, and an interactive setting; and store, by the video editor, as an output video file, the static video data, metadata comprising the timeline, the dynamic content, and the settings for display of the 3D object.

Another example system comprises: a processor; and a computer-readable medium storing instructions that are operative upon execution by the processor to: open, by a video player, a video file, the video file comprising static video data, dynamic content comprising a 3D object, metadata comprising a timeline, and settings for display of the 3D object, wherein the timeline comprises a start time for presenting the dynamic content along with the static video data; play the static video data; and based on at least the start time for presenting the dynamic content, display the 3D object along with the static video data according to the settings for display of the 3D object, wherein the settings for display of the 3D object comprises a zoom factor and/or a viewing parameter.

An example computer-implemented method comprises: generating a timeline in a video editor; receiving static video data into the timeline; receiving, into the video editor, dynamic content comprising a 3D object; identifying, within the timeline, a start time for presenting the dynamic content along with the static video data; presenting, in the video editor, a settings editor having settings for display of the 3D object, wherein the settings for display of the 3D object comprises at least one setting selected from the list consisting of: a zoom factor, a viewing parameter, and an interactive setting; and storing, by the video editor, as an output video file, the static video data, metadata comprising the timeline, the dynamic content, and the settings for display of the 3D object.

Another example computer-implemented method comprises: opening, by a video player, a video file, the video file comprising static video data, dynamic content comprising a 3D object, metadata comprising a timeline, and settings for display of the 3D object, wherein the timeline comprises a start time for presenting the dynamic content along with the static video data; playing the static video data; and based on at least the start time for presenting the dynamic content, displaying the 3D object along with the static video data according to the settings for display of the 3D object, wherein the settings for display of the 3D object comprises a zoom factor and/or a viewing parameter.

One or more example computer storage devices have computer-executable instructions stored thereon, which, on execution by a computer, cause the computer to perform operations comprising: generating a timeline in a video editor; receiving static video data into the timeline; receiving, into the video editor, dynamic content comprising a 3D object; identifying, within the timeline, a start time for presenting the dynamic content along with the static video data; presenting, in the video editor, a settings editor having settings for display of the 3D object, wherein the settings for display of the 3D object comprises at least one setting selected from the list consisting of: a zoom factor, a viewing parameter, and an interactive setting; and storing, by the video editor, as an output video file, the static video data, metadata comprising the timeline, the dynamic content, and the settings for display of the 3D object.

One or more additional example computer storage devices have computer-executable instructions stored thereon, which, on execution by a computer, cause the computer to perform operations comprising: opening, by a video player, a video file, the video file comprising static video data, dynamic content comprising a 3D object, metadata comprising a timeline, and settings for display of the 3D object, wherein the timeline comprises a start time for presenting the dynamic content along with the static video data; playing the static video data; and based on at least the start time for presenting the dynamic content, displaying the 3D object along with the static video data according to the settings for display of the 3D object, wherein the settings for display of the 3D object comprises a zoom factor and/or a viewing parameter.

Alternatively, or in addition to the other examples described herein, examples include any combination of the following:
opening, by a video player, the output video file;
playing the static video data;
based on at least the start time for presenting the dynamic content, displaying the 3D object along with the static video data;
while displaying the 3D object, based on at least the interactive setting permitting user adjustment, and further based on at least receiving a user adjustment input, adjusting the zoom factor and/or the viewing parameter of the 3D object;
while displaying the 3D object, based on at least the interactive setting permitting user adjustment, displaying an indication that a user adjustment is available;
prior to storing the output video file, identifying, within metadata that comprises the timeline, a stop time to cease presenting the dynamic content along with the static video data;
based on at least the stop time for presenting the dynamic content, ceasing display of the 3D object by the video player;
the interactive setting either permits or prohibits user adjustment of the zoom factor and/or the viewing parameter of the 3D object;
the settings for display of the 3D object are stored within the metadata or the dynamic content;
receiving the dynamic content comprising the 3D object comprises, opening, by the video editor, an object data file comprising a 3D object file format;
identifying, within metadata that comprises the timeline, positioning information for positioning a display of the dynamic content relative to a display of the static video data;
receiving, by the video editor, user selections for the settings of the settings editor;
displaying, in the video editor, the timeline;
displaying, in the video editor, images from the static video data at time points in the timeline;
displaying, in the video editor, the 3D object;
the static video data comprises both a static video stream and a static audio stream synchronized with the static video stream;
receiving the static video data comprises, opening, by the video editor, a first video file in a first video file format, wherein the first video file format comprises a video format selected from the list consisting of: MP4, MOV, AVI, WMV, MKV, WebM, OGV, and QTFF;
receiving the dynamic content comprising the 3D object comprises receiving a reference to an object data file comprising a 3D object file format;
the reference comprises a uniform resource locator (URL) or a hyperlink indicating the source of the object data file;
the interactive setting further either permits or prohibits user adjustment of positioning the display of the dynamic content;
the video editor comprises a plug-in to an internet browser;
the video editor executes remotely from the internet browser, but is shown within an internet browser window;
the video player comprises a plug-in to an internet browser;
the video player executes remotely from the internet browser, but is shown within an internet browser window;
displaying the indication that a user adjustment is available is based on at least a pointer control hovering over a display position of the 3D object;
the pointer control comprises a cursor or a touch on a touchscreen; and
the indication that a user adjustment is available comprises a tooltip.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912 (i.e., a computer-readable medium), one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more buses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein. Thus, computing device 900 comprises a computer storage device having computer-executable instructions 912b stored thereon.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represents an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™M branded communications, or the like), or a combination thereof. Network component 924 communicates over wireless communication link 926 and/or a wired communication link 926a to a remote resource 928 (e.g., a cloud resource) across a computer network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a processor; and
a computer-readable medium storing instructions that are operative upon execution by the processor to:
generate a timeline in a video editor;
receive static video data into the timeline;
receive, into the video editor, dynamic content comprising a three-dimensional (3D) object;
present, in the video editor, a settings editor having display settings for the 3D object, wherein the display settings for the 3D object comprise an interactive setting; and
store, by the video editor, as an output video file, the static video data, metadata comprising the timeline, the dynamic content, and the display settings for the 3D object, wherein the display settings for the 3D object are stored within the metadata or the dynamic content.

2. The system of claim 1, wherein the instructions are further operative to:
open, by a video player, the output video file;
play the static video data; and
based on at least a start time for presenting the dynamic content, display the 3D object along with the static video data.

3. The system of claim 2, wherein the instructions are further operative to:
while displaying the 3D object, based on at least the interactive setting permitting user adjustment, and further based on at least receiving a user adjustment input, adjust a zoom factor and/or a viewing parameter of the 3D object.

4. The system of claim 2, wherein the instructions are further operative to:
while displaying the 3D object, based on at least the interactive setting permitting user adjustment, display an indication that a user adjustment is available.

5. The system of claim 2, wherein the instructions are further operative to:
prior to storing the output video file, identify, within metadata that comprises the timeline, a stop time to cease presenting the dynamic content along with the static video data; and
based on at least the stop time for presenting the dynamic content, cease display of the 3D object by the video player.

6. The system of claim 1,
wherein the interactive setting either permits or prohibits user adjustment of a zoom factor and/or a viewing parameter of the 3D object;

7. A computer-implemented method comprising:
generating a timeline in a video editor;
receiving static video data into the timeline;
receiving, into the video editor, dynamic content comprising a three-dimensional (3D) object;
presenting, in the video editor, a settings editor having display settings for the 3D object, wherein the display settings for the 3D object comprise an interactive setting; and
storing, by the video editor, as an output video file, the static video data, metadata comprising the timeline, the dynamic content, and the display settings for the 3D object, wherein the display settings for the 3D object are stored within the metadata or the dynamic content.

8. The computer-implemented method of claim 7, further comprising:
opening, by a video player, the output video file;
playing the static video data; and
based on at least a start time for presenting the dynamic content, displaying the 3D object along with the static video data.

9. The computer-implemented method of claim 8, further comprising:
while displaying the 3D object, based on at least the interactive setting permitting user adjustment, and further based on at least receiving a user adjustment input, adjusting a zoom factor and/or a viewing parameter of the 3D object.

10. The computer-implemented method of claim 8, further comprising:
while displaying the 3D object, based on at least the interactive setting permitting user adjustment, displaying an indication that a user adjustment is available.

11. The computer-implemented method of claim 8, further comprising:
prior to storing the output video file, identifying, within metadata that comprises the timeline, a stop time to cease presenting the dynamic content along with the static video data; and
based on at least the stop time for presenting the dynamic content, ceasing display of the 3D object by the video player.

12. The computer-implemented method of claim 7,
wherein the interactive setting either permits or prohibits user adjustment of the a zoom factor and/or a viewing parameter of the 3D object;

13. The computer-implemented method of claim 7, wherein receiving the dynamic content comprising the 3D object comprises opening, by the video editor, an object data file comprising a 3D object file format.

14. The computer-implemented method of claim 7, further comprising:
identifying, within metadata that comprises the timeline, positioning information for positioning a display of the dynamic content relative to a display of the static video data.

15. The computer-implemented method of claim 7, further comprising:
receiving, by the video editor, user selections for the settings of the settings editor;
displaying, in the video editor, the timeline;
displaying, in the video editor, images from the static video data at time points in the timeline; and
displaying, in the video editor, the 3D object.

16. A computer storage device having computer-executable instructions stored thereon, which, on execution by a computer, cause the computer to perform operations comprising:
generating a timeline in a video editor;
receiving static video data into the timeline;
receiving, into the video editor, dynamic content comprising a three-dimensional (3D) object;
presenting, in the video editor, a settings editor having display settings for the 3D object, wherein the display settings for display of the 3D object comprise an interactive setting; and
storing, by the video editor, as an output video file, the static video data, metadata comprising the timeline, the dynamic content, and the display settings for display of the 3D object, wherein the settings for display of the 3D object are stored within the metadata or the dynamic content.

17. The computer storage device of claim 16, wherein the operations further comprise:
opening, by a video player, the output video file;
playing the static video data; and
based on at least the a start time for presenting the dynamic content, displaying the 3D object along with the static video data.

18. The computer storage device of claim 17, wherein the operations further comprise:
while displaying the 3D object, based on at least the interactive setting permitting user adjustment, and further based on at least receiving a user adjustment input, adjusting a zoom factor and/or a viewing parameter of the 3D object.

19. The computer storage device of claim 17, wherein the operations further comprise:
while displaying the 3D object, based on at least the interactive setting permitting user adjustment, displaying an indication that a user adjustment is available.

20. The computer storage device of claim 16,
wherein the interactive setting either permits or prohibits user adjustment of a zoom factor and/or a viewing parameter of the 3D object;
